(19) United States
(12) Patent Application Publication
(10) Pub. No.: US 2026/0268602 A1
(43) Pub. Date: Sep. 10, 2026

(54) LLM-BASED 3D COPILOT FOR SCENE GENERATION AND EDITING

(71) Applicant: Adobe Inc., San Jose, CA (US)

(72) Inventors: Yu Shen, Oakland, CA (US); Yiqin Zhao, Ithaca, NY (US); Stefano Petrangeli, San Francisco, CA (US); Matheus Gadelha, San Jose, CA (US); Gang Wu, San Jose, CA (US); Cuong Nguyen, San Francisco, CA (US)

(21) Appl. No.: 19/072,182

(22) Filed: Mar. 6, 2025

(51) Int. Cl. G06T 17/20

(52) U.S. Cl. CPC G06T 17/20

(57) ABSTRACT

A large language model (LLM)-based scene generator receives a natural language prompt including instructions to generate a three-dimensional scene. The LLM-based scene generator generates, using a first machine-learning model, a scene graph based on the natural language prompt. The first machine-learning model generates the scene graph by generating a representation of one or more objects oriented within a two-dimensional environment of the scene graph and subdividing the two-dimensional environment into one or more subparts. The one or subparts represent contextually distinct portions of the two-dimensional environment. The LLM-based scene generator modifies a representation of a subpart of the one or more subparts by adding additional objects within the subpart. The additional objects are contextually related to the subpart. The LLM-based scene generator renders the scene graph into the three-dimensional scene using a second machine-learning model. The LLM-based scene generator generates the three-dimensional scene.

### TECHNICAL FIELD

This disclosure relates to content generation, and more particularly to generating three-dimensional scenes using a large language model.

### BACKGROUND

Recent advancements in machine learning have enabled the generation of images using large language models (LLMs) in conjunction with multimodal neural networks. LLMs, pre-trained on extensive datasets comprising textual and contextual knowledge, can interpret natural language inputs to define parameters for image generation.

### SUMMARY

Methods and systems are described herein for generating a three-dimensional scene. An LLM-based scene generator receives, from a user device for example, a natural language prompt for a large language model (LLM)-based scene generator that includes instructions to generate or modify a three-dimensional scene. The natural language prompt includes one or more instructions for generating a scene and/or modifying an existing scene. The LLM-based scene generator generates, using a first machine-learning model, a scene graph based on the natural language prompt. To generate the scene graph, the first machine-learning model generates a representation of one or more objects oriented within a two-dimensional environment of the scene graph. The first machine-learning model then subdivides the one or more objects of the two-dimensional environment into one or more subparts. The one or subparts represent contextually distinct portions of the two-dimensional environment. The LLM-based scene generator modifies a representation of a subpart of the one or more subparts by adding additional objects within the subpart. The additional objects are contextually related to the subpart. By utilizing a subdivision technique (e.g., a multi-step reasoning workflow, the LLM-based scene generator is able to create a scene graph with an increased level of detail by gradually increasing the granularity in which objects are added to the scene graph. The LLM-based scene generator renders the scene graph into the three-dimensional scene using a second machine-learning model. The LLM-based scene generator generates the three-dimensional scene. In some examples, the user device transmits a second natural language prompt to modify the scene graph, resulting in a highly-detailed scene graph with simple user input.

The methods, systems, and non-transitory computer-readable media and systems described herein include various media editing systems and operations as previously described.

These illustrative examples are mentioned not to limit or define the disclosure, but to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 illustrates an example division of sub-regions using a multi-step reasoning workflow of an LLM-based scene generator according to some aspects of the present disclosure.

FIG. 2 illustrates an example block diagram of the LLM-based scene generator according to some aspects of the present disclosure.

FIG. 3A illustrates an example block diagram of an assistive scene generation module of the LLM-based scene generator according to some aspects of the present disclosure.

FIG. 3B illustrates an example block diagram of a multi-step planning module of the LLM-based scene generator according to some aspects of the present disclosure.

FIG. 3C illustrates an example block diagram of a scene graph agent of the LLM-based scene generator according to some aspects of the present disclosure.

FIG. 3D illustrates an example block diagram of a code generation agent of the LLM-based scene generator according to some aspects of the present disclosure.

FIG. 4 illustrates an example flowchart for generating a three-dimensional scene using the LLM-based scene generator according to some aspects of the present disclosure.

FIG. 5 illustrates an example of a computing system capable of executing the processes of the LLM-based scene generator according to some aspects of the present disclosure.

### DETAILED DESCRIPTION

Methods and systems are described herein for generating three-dimensional scenes. Conventional techniques for three-dimensional content generation use complex user interfaces that introduce a steep learning curve for content creators. For example, manual modeling tools (e.g., CAD modeling, polygonal modeling, sculpting, etc.) require a high level of expertise to operate effectively and current algorithmic approaches do not achieve a high level of detail in large-scale scene generation applications. Additionally, generating high-quality and large-scale three-dimensional scenes can be computationally intensive, making iterative evaluating and refining of three-dimensional scene design difficult. Three-dimensional scene modeling and visualization are time-consuming processes that require labor-intensive manual adjustments and fine-tuning of three-dimensional objects.

The present techniques include a novel three-dimensional scene-creating copilot system that allows high-quality and iterative three-dimensional scene modeling and visualization. This is performed by leveraging a multi-step reasoning workflow to control language and image-generative agents to create three-dimensional scenes. Compared to traditional three-dimensional modeling and visualization workflows, the present technique provides more natural and intuitive control and can significantly reduce the time required to create three-dimensional content. The present techniques enable generating tailored scene layouts with sophisticated object layout planning with consideration to object looks and styles. The generated object layouts facilitate generating photorealistic rendering with diffusion-based rendering models. Compared to traditional creative workflows, the present techniques operate using simple user input and quickly deliver high-quality results that cater to diverse aesthetic preferences and spatial arrangements. Using the “chain-of-thought” (e.g., natural language instructions) generation pipeline and several reasoning and validation steps, the present techniques ensure an overall quality of the generated 3D scenes.

The present techniques include an LLM-based scene generator that generates detailed scene graphs from natural language prompts. The LLM-based scene generator receives a natural language prompt via an application associated with a user device. The LLM-based scene generator analyzes the natural language prompt using an assistive scene generation module. In addition to the natural language prompt, in some examples, the assistive scene generation module receives a scene graph. In some examples, the scene graph is a reference scene graph (e.g., previously generated scene graphs, predefined scene graphs, etc.). For example, the LLM-based scene generator stores one or more reference scene graphs and modifies the one or more reference scene graphs based on the natural language prompt. In some examples, the LLM-based scene generator selects a reference scene graph of the one or more reference scene graphs to use based on the natural language prompt. In some other examples, the user device selects a reference scene graph of the one or more reference scene graphs to modify with the natural language prompt. In other examples, the scene graph is from a previous iteration of the LLM-based scene generator. In still yet other examples, the LLM-based scene generator generates a new scene graph from the natural language prompt.

The LLM-based scene generator uses a multi-step reasoning workflow that iteratively modifies sub-regions of the scene graph. The assistive scene generation module proceeds through one or more levels of scene generation to iteratively add additional detail and complexity to regions of the scene graph. For example, a first level includes a park; a second level includes a playground, pavilion, and pond; and a third level includes a jungle gym, slide, and monkey bars. By using the multi-step reasoning workflow, the LLM-based scene generator generates high-quality, detailed, and large-scale scenes. Further, by using the natural language prompts from the user device, three-dimensional scene generation can be much more intuitive and computationally efficient and allow for users to quickly generate high-quality renderings (e.g., three-dimensional renderings, two-dimensional representations of three-dimensional renderings). The assistive scene generation module modifies the scene graph using the multi-step reasoning workflow, generating a modified scene graph that incorporates instructions included in the natural language prompt. This method provides high-quality scene creation without labor-intensive manual adjustments or fine-tuning.

The assistive graph generation module transmits the modified scene graph to a post-processing module, which renders the modified scene graph into a 3D scene. The modified scene graph includes object category information for objects placed within the modified scene graph by the assistive graph generation module. The post-processing module utilizes the object category information to retrieve model assets. The post-processing module uses the orientation information of the modified scene graph to orient the model assets and compose a 3D scene according to the modified scene graph.

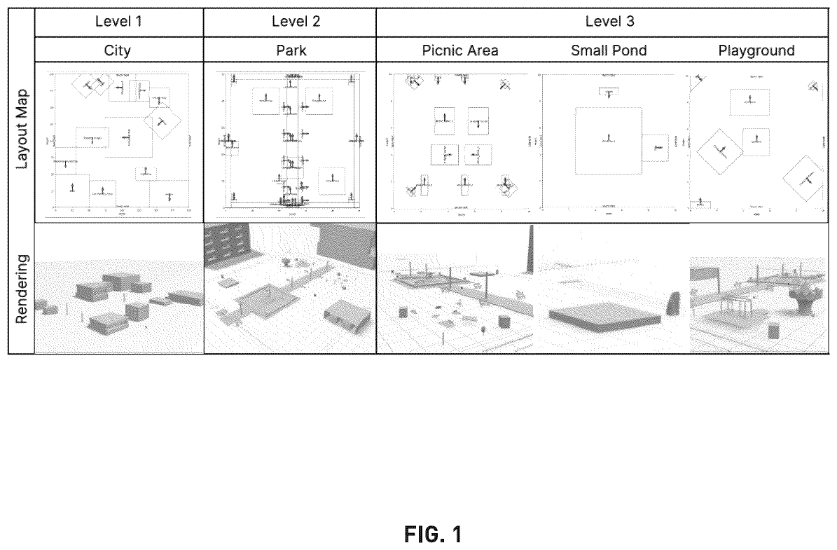

FIG. 1 illustrates an example division of sub-regions using a multi-step reasoning workflow of an LLM-based scene generator according to some aspects of the present disclosure. In some examples, and as used throughout the present disclosure, “scene” refers to a three-dimensional scene. However, in some alternative implementations, “scene” refers to a two-dimensional scene that includes the same or similar qualities as the three-dimensional scene. The LLM-based scene generator generates highly detailed 3D scenes (e.g., such as images, video, etc.) based input received from one or more remote devices. For instance, the LLM-based scene generator receives an input from a user device. In some examples, the input is a natural language prompt (e.g., “generate a city with a park on the southwest side. The park size is 50 m in width and 50 m in length,” “add a fountain in the southeast corner of the park,” “generate a two-story suburban home with three bedrooms, two bathrooms, and an open-concept living space,” etc.). In some examples, the input is directed to an existing scene graph (e.g., a reference scene graph). In some other examples, the prompt is initiates generation of a new scene graph using a reference scene graph (e.g., selected by the user device from a series of one or more reference scene graphs provided by the LLM-based scene generator, selected by the LLM-based scene generator based on the natural language prompt, etc.). In some other examples, the prompt initiates generation of a new scene graph.

LLMs understand complex natural language inputs by leveraging neural networks, often based on transformer architectures, which are trained on vast amounts of text data. These models use tokenization to break inputs into units and attention mechanisms to capture contextual relationships between words and phrases. By identifying patterns and semantic structures in the input, LLMs generate outputs that align with user intents.

By leveraging this capability of LLMs, the LLM-based scene generator uses a multi-step reasoning workflow that utilizes the built-in knowledge of LLMs to generate high-quality, open-set (e.g., the LLM is capable of generating content for an unconstrained range of objects, environments, and configurations, including those not included in training data associated with the LLM) 3D scenes. The multi-step reasoning workflow explicitly instructs the LLM to plan object positions in the scene graph, plan object orientations in the scene graph, and plan relative spatial relationship between one or more objects in the scene graph. In some examples, the multi-step reasoning workflow generates the scene graph according to multiple conditions, including, but not limited to, types of objects included in the scene graph, number of objects included in the scene graph, size of the scene in the scene graph, any combination thereof, or the like. In some examples, the conditions are received from the user device. In some examples, the conditions are configured according to parameters associated with the LLM-based scene generator.

The multi-step reasoning workflow defines a hierarchy of levels within the scene graph for iteratively adjusts a resolution of the scene graph at each level, where each subsequent level defines a sub-region of the previous level. The multi-step reasoning workflow generates the layout map by iteratively progressing through the hierarchical “levels” of the scene graph. The multi-step reasoning workflow defines level one (e.g., the top-most level in the hierarchy) to include the full layout map. The multi-step reasoning workflow classifies regions of the layout map based on a context associated with the objects of the layout map. The multi-step reasoning workflow defines each sub-region classified from level one to be a level two sub-region of the level one region. The multi-step reasoning workflow classifies zero or more sub-regions within each level two sub-region. The multi-step reasoning workflow defines each sub-region classified from level two to be a level three sub-region of the level two region. The process continues adding levels to the hierarchy until a threshold depth is reached (e.g., a threshold quantity of levels, etc.) or until a threshold detail is reached (e.g., determined based on input from the user device, based on the natural language prompt, internal parameters, combinations thereof, and/or the like).

For example, the LLM starts with large-scale portions (a first level) of the scene graph (e.g., a layout for a city with a park, a downtown, a residential area, and a school). The first level portions are associated with a context generated by the LLM based on the natural language prompt. For example, the natural language prompt may be, “generate a city with a park and a library.” Based on the natural language prompt, the LLM generates first level portions associated “park,” “library,” “school,” “shopping center,” “residential area,” or any other context that could be relevant to the natural language prompt. The LLM then classifies sub-regions within the first level portions that are smaller than the large-scale portion (a second level) (e.g., a layout for the park within the city, a layout for a subdivision in the residential area, etc.). The LLM is trained to select the second level portions according to the context associated with the respective first level. For example, a road and a park are identified at the first level by the LLM. In this example, a park includes more detail than a road, therefore the number of second level portions associated with the road is less than the number of second level portions associated with the park. In some examples, the strategic selection of second level (and subsequent levels) portions is determined by the LLM. In some examples, the strategic selection of second level (and subsequent levels) portions is determined based on the natural language instruction. For example, the natural language instruction may indicate a particular focus on a portion of the scene graph (e.g., “generate a modern city that is hosting a county fair at the local fairgrounds with cows, chicken, and horses,” “add additional detail to the fairgrounds,” etc. where the focus of the second instruction indicates a focus on the fairgrounds).

The second level portions are associated with the respective context of the associated first level portion (e.g., the first level portion is associated with the “park” context, therefore the second level portions are also associated with the “park” context). One or more objects are added within the second level. The contextual information associated with the regions of the scene graph improve the technical quality and accuracy of the scene graph (e.g., preventing unrealistic layouts in the scene graph, such as a used car dealership within a city park). In some examples, the second level portions are further divided into additional sub-regions (e.g., a third level, a fourth level, an “n” level, etc.) (e.g., a layout for a playground on the park within the city, the layout of a cul-de-sac of the subdivision in the residential area). For example, the multi-step reasoning workflow identifies a first level portion, then splits the first level portion into second level portions, then splits the second level portions into third level portions. The multi-step reasoning workflow continues to generate subsequent levels until the scene graph achieves a level of completeness indicated by the natural language prompt. In some examples, the LLM-based scene generator includes a configuration that defines a minimum number of levels for the scene graph. The minimum number of levels is based on at least one of settings associated with the LLM-based scene generator, a size of the scene graph requested by the natural language prompt, a threshold associated with the size of the levels (e.g., no more levels are generated after a portion of a level is smaller than a threshold minimum size associated with the LLM-based scene generator), any combination thereof, or the like.

As an illustrative example, as shown in FIG. 1, the LLM-based scene generator generates a large-scale level of “city” using a, such as, “generate a city with a park on the southwest side. The park size is 50 m in width and 50 m in length.” The LLM-based scene generator generates a city scene that includes, but is not limited to, a shopping mall, a school, a park, an office building, a car parking area, a gym, and a library, which are represented by the rectangles within a two-dimensional plane associated with the scene graph (e.g., “layout map”). The arrows within each element indicate an orientation of the element relative to scene graph (e.g., front of the shopping mall facing west, front of the school facing south, etc.).

In some examples, the multi-step reasoning workflow represents the hierarchy of levels as a tree-like structure where the top node corresponds to level one. Level two includes one or more nodes connected to the top node representing the one or more regions classified from the level one region. Level three includes one or more nodes connected to a level two node representing the one or more regions classified from the level two region. And so on. Each node shares a context with its “parent” nodes (e.g., the nodes that precede the node from the top node). For example, the “park” (e.g., a level two sub-region of “city” the level one region) is divided into one or more sub-regions that are associated with the same context as “park.” As shown, “Level Two” includes three sub-regions that are level three sub-regions including, but not limited to, a picnic area, a playground, a small pond, a restroom, a pathway, and lampposts. The multi-step reasoning workflow divides the three sub-regions into further sub-regions to generate accurately-depicted representations within the scene graph. The picnic area includes at least picnic tables, grills, and lights, which are associated with the same context as “picnic area.” The small pond includes at least a pond and a bench, which are associated with the same context as “small pond.” The playground includes at least swings, slides, and a jungle gym, which are associated with the same context as “playground.”

In some examples, the LLM translates the layout map (of the scene graph) that includes one or more “levels” (e.g., level one, level two, and level three) =into a 3D mesh of the scene graph. For example, the LLM directly translates the buildings, structures, infrastructure, lighting, roads, sidewalks, architecture, and other objects indicated in the layout map into a 3D equivalent that corresponds to one or more conditions of the object (e.g., spatial information, orientation, size, color, etc.). In some examples, a GUI associated with a user interface of the user device presents the 3D mesh.

In some examples, the LLM-based scene generator, using the layout map, is used to generate the 3D mesh. In some examples, the LLM-based scene generator retrieves 3D model assets corresponding to the object of the layout map using a Contrastive Language-Image Pre-training Model (CLIP) score. A CLIP score is a similarity metric derived from a CLIP model, which evaluates an alignment between an image and a textual description by mapping both inputs into a shared multimodal embedding space. The score is calculated using cosine similarity between the image and text embeddings, enabling precise quantification of their semantic correspondence. In some examples, the LLM-based scene generator retrieves 3D model assets using object morphology front identification via visual prompting. In this example, the LLM-based scene generator renders a set of four object renderings associated with an object of the layout map and prompt the LLM to identify the morphology front so that the 3D model asset correctly aligns with the object of the layout map.

The 3D mesh is used to generate a life-like rendering of the scene graph. In some examples, the rendering is generated by a process that includes a machine-learning model (e.g., an LLM). In some other examples, the rendering is generated using rendering methods that do not include a machine-learning model. The LLM-based scene generator presents the rendering via the user interface of the user device. The user device transmits additional natural language prompts pertaining to the scene graph indicating modifications to the scene graph. For example, the user device transmits instructions such as, “add more picnic tables to the picnic area,” “move the swings closer to the slides on the playground,” “add a basketball court to the park,” etc.

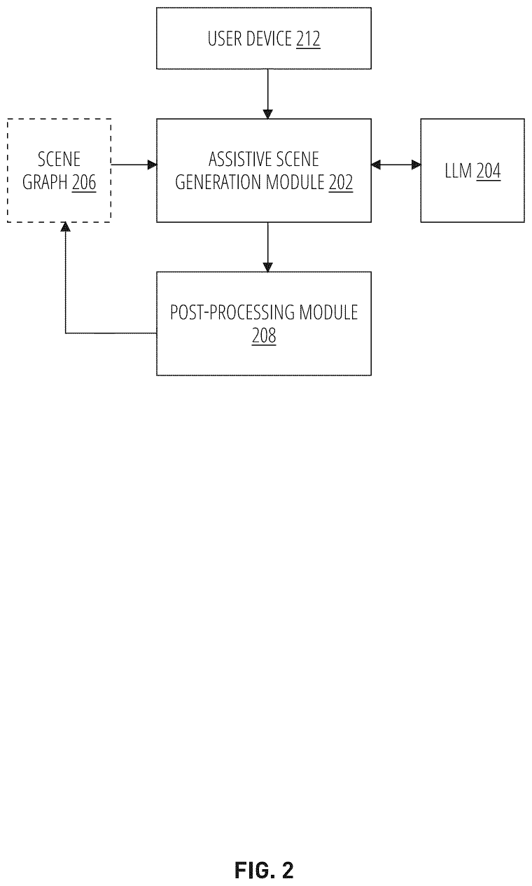

FIG. 2 illustrates an example block diagram of the LLM-based scene generator according to some aspects of the present disclosure. The LLM-based scene generator includes at least the components described herein, which work in conjunction to perform the operations described herein. In some examples, additional components are added to the LLM-based scene generator to perform some of the operations described herein. In some examples, two or more of the components described herein are combined into one component (e.g., post-processing module 208 is incorporated into assistive scene generation module 202).

In some examples, user device 212 accesses a user interface configured to input commands into assistive scene generation module 202. In some examples, the user interface is generated by an application associated with the LLM-based scene generator. User device 212 includes at least one input device, including, but not limited to, a touchscreen, a keyboard, a microphone, a mouse, or a touch pad. In some examples, user device 212 accesses the LLM-based scene generator via an application of user device 212 In some other examples, user device 212 accesses the LLM-based scene generator using a communication network (e.g., accessing a cloud-based instance of the LLM-based scene generator, accessing the LLM-based scene generator using the Internet, etc.). In some examples, the user interface accessed by user device 212 displays a graphical user interface (GUI) that facilitates the transmission of data and/or information to assistive scene generation module 202. In some examples, the GUI offers user-friendly 3D scene editing operations, such as asset importing, object manipulation, and layout adjustment.

In some examples, the assistive scene generation module 202 receives natural language instructions from user device 212 via keyboard input, touchscreen input, microphone input, any combination thereof, or the like. In some examples, the natural language instructions are associated with an existing scene graph (e.g., performing a modification on a pre-existing scene graph that was generated in a previous iteration of the assistive scene generation module 202). In some other examples, the natural language instructions are associated with instructions to generate a new scene graph. Using the natural language instructions, assistive scene generation module 202 can create open-set and large-scale 3D scenes that do not require domain-specific data at any stage.

In some examples, LLM 204 is configured to perform the operations of assistive scene generation module 202. In some examples, LLM 204 understands complex natural language inputs and generate structured outputs that follow rigorous rules. Leveraging this key capability of LLM 204, LLM 204 receives the natural language instructions and generates a 3D mesh of a scene graph. In some examples, LLM 204 is comprised of two or more machine-learning models configured to perform the operations described herein, including, but not limited to, the operations disclosed in FIG. 1-FIG. 4. For example, LLM 204 may include a large language model for processing natural language communications and one or more generative-based models such as, but not limited to, a diffusion model for generating three-dimensional scenes. In other examples, LLM 204 is a diffusion-based LLM that process natural language communications and generates three-dimensional scenes.

In some examples, the assistive scene generation module 202 utilizes a training system to train LLM 204 using datasets through supervised learning, reinforcement learning, or a combination of both. For example, LLM 204 is trained using historical scene graphs and respective natural language instructions. To further refine LLM 204, a feedback loop is employed during fine-tuning and updating, where assistive scene generation module 202 evaluates the model's responses. This feedback is used to adjust model parameters, improving accuracy, coherence, and alignment with user expectations over time.

Assistive scene generation module 202 utilizes a multi-step reasoning workflow using LLM 204 to create high-quality scene graphs comprised of at least layout maps and 3D meshes of the layout maps (e.g., scene graphs). Specifically, the multi-step reasoning workflow of assistive scene generation module 202 instructs LLM 204 to plan object positions, orientations, and relative spatial relationships. LLM 204 may be trained to implement the multi-step reasoning workflow using one or more training techniques, including, but not limited to, supervised learning, unsupervised learning, reinforcement learning, few-shot or zero-shot learning, etc. In some examples, assistive scene generation module 202 also instructs LLM 204 to configure the scene graph with multiple conditions, such as object types, number of objects, scene sizes, any combination thereof, or the like. The multi-step reasoning workflow of assistive scene generation module 202 defines a hierarchy of levels using a scene subdivision algorithm that defines levels of a layout map and iteratively defines sub-levels of previous level according to large scene graph generation goals indicated by the natural language instruction. The scene subdivision algorithm maintains reasoning complexity and achieves overall high generation quality (e.g., improved accuracy of scenes, increased level of detail, etc.). Specifically, assistive scene generation module 202 generates high-level planning for a scene (e.g., a broad subject matter associated with the scene), such as a city, and then divides the scene into sub-regions (e.g., a park, a school, a shopping center, etc.), based on the region sizes and contexts. During each subdivision, assistive scene generation module 202 creates a context-inheriting prompt to combine a goal associated with the previous level (e.g., generating a park, generating a school, generating a living room, generating an amusement park, generating a county fair, etc.) with the current level. Assistive scene generation module 202 generates a layout map of the scene graph, which demonstrates a two-dimensional (2D) representation of the scene with references to one or more objects associated with the scene graph. In some examples, the layout map includes references indicating the size and/or orientation of the one or more objects associated with the scene graph.

Assistive scene generation module 202, based on the layout map, generates a 3D mesh of the scene graph. The 3D mesh is a 3D representation of the layout map that demonstrates the size, orientation, spacing, layout, etc. of the scene graph in a 3D space. In some examples, the 3D mesh does not include intricate details of the one or more objects within the scene graph. For example, the 3D mesh represents a building as a rectangular prism, the 3D mesh represents a bush as a sphere, and the 3D mesh represents a fountain as a cylinder. This 3D mesh includes object category information and detailed spatial information such as sizing and positions. In some examples, assistive scene generation module 202 creates object orientation angles in the layout map. The assistive scene generation module 202 retrieves 3D model assets and composites the 3D model assets into the layout map. In some examples, assistive scene generation module 202 retrieves 3D model assets that correspond to the one or more objects of the layout map. In some examples, the assistive scene generation module 202 accesses the 3D model assets at a location accessible to assistive scene generation module 202, such as a local database, a cloud-based database, a marketplace/database associated with a communication network (e.g., the Internet), any combination thereof, or the like. Assistive scene generation module 202 identifies a first object to render within the scene graph and matches the first object to a corresponding 3D model asset based on data associated with the first object with the scene graph (e.g., a description, an orientation, a context, etc.). In some examples, the assistive scene generation module 202 identifies the corresponding 3D model asset using CLIP score-based asset matching between a name associated with the first object and a rendered image. In some examples, the assistive scene generation module 202 identifies the corresponding 3D model using object morphology front identification via visual prompting. In this example, the assistive scene generation module 202 renders a set of four object renderings and prompt LLM 204 to identify its morphology front so that it correctly aligns with the planned object orientation in the scene graph.

In some examples, assistive scene generation module 202 outputs the scene graph (e.g., the 3D mesh and the layout map) to post-processing module 208 to generate a rendering. This scene graph includes object category information and detailed spatial information such as sizing and positions. In some examples, assistive scene generation module 202 creates object orientation angles in the scene graph. The post-processing module 208 retrieves 3D model assets and composites the 3D model assets into the scene graph. In some examples, post-processing module 208 uses a machine-learning model (e.g., LLM 204) to generate the rendering. In some other examples, post-processing module does not use a machine-learning model to generate the rendering. The LLM-based scene generator presents the rendering via the user interface of user device 212. In some examples, the LLM-based scene generator presents the rendering on a GUI associated with an application associated with user device 212 (e.g., downloaded locally on user device 212, a cloud-based application accessed by user device 212, etc.). In some other examples, the LLM-based scene generator presents the rendering on a GUI associated with a web interface (e.g., an Internet-based interface) accessed by user device 212 through a communication network. In some examples, the user associated with user device 212 analyzes the rendering and exports the rendering. In some other examples, user device 212 transmits a second natural language instruction to assistive scene generation module 202 indicating modifications to the rendering and associated scene graph. In some examples, scene graph 206 is a reference scene graph utilized by assistive scene generation module 202 to generate a modified scene graph. In some examples, scene graph 206 is a result of a previous natural language prompt from user device 212. As an illustrative example, a first natural language prompt is, “generate a city with a park on the southwest side.” The LLM-based scene generator generates a first scene graph according to the first natural language prompt, then subsequently receives a second natural language prompt, stating, “add three fountains to the park.” The LLM-based scene generator generates a second scene graph by modifying the first scene graph to include three fountains.

In some other examples, scene graph 206 is a reference scene graph selected by assistive scene generation module 202 (e.g., LLM 204) from a database of one or more reference scene graphs to serve as a starting point for assistive scene generation module 202 to modify according to a natural language prompt from user device 212.

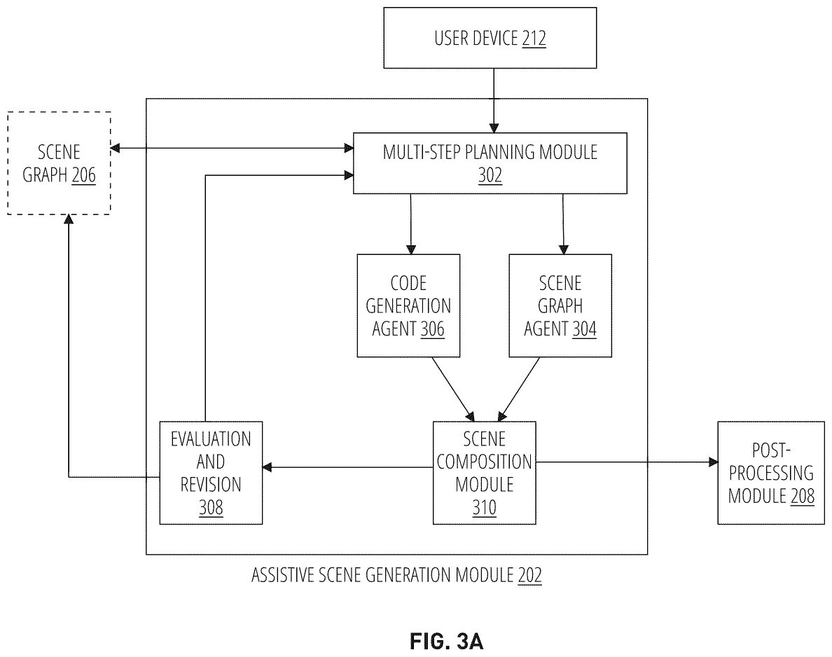

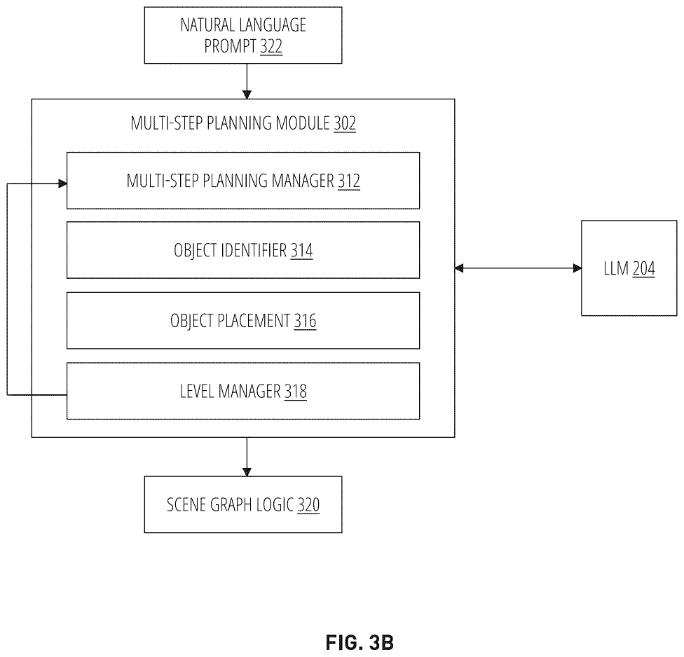

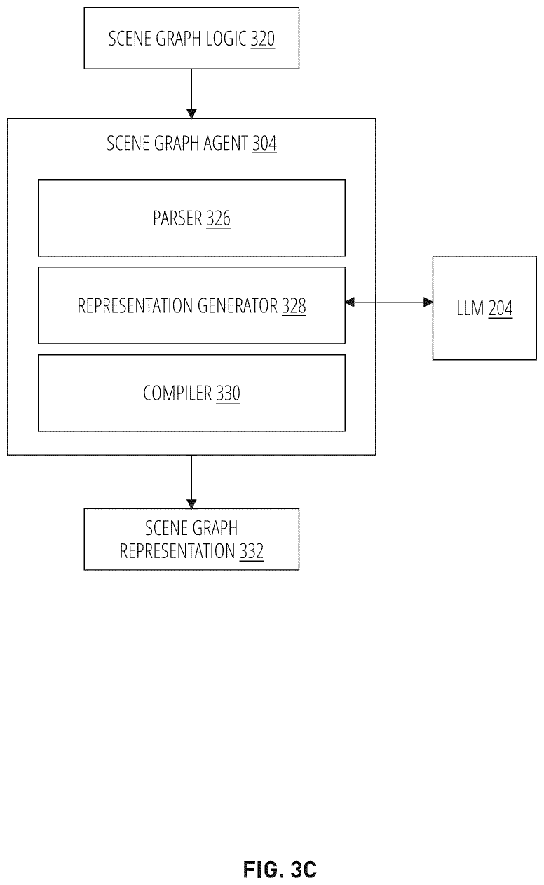

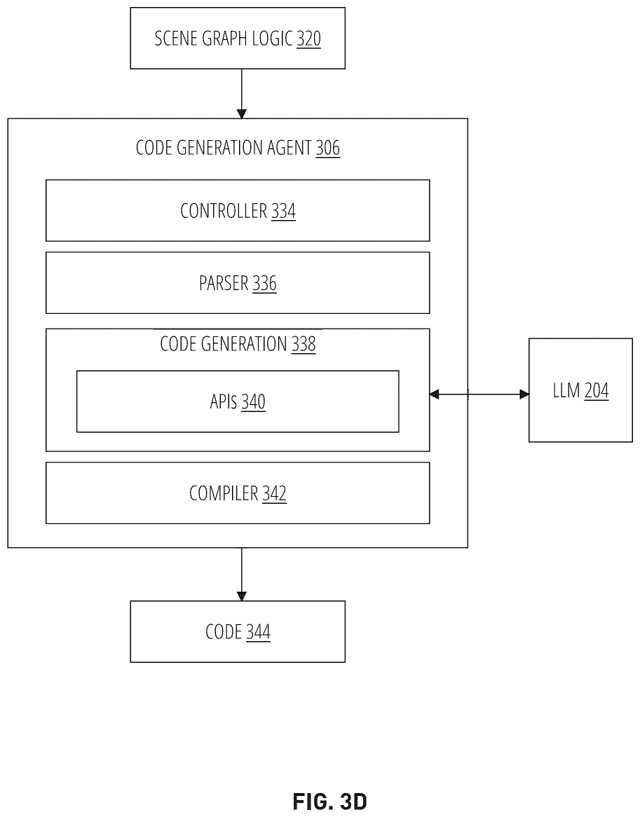

FIG. 3A illustrates an example block diagram of an assistive scene generation module of the LLM-based scene generator according to some aspects of the present disclosure. As mentioned above in FIG. 1 and FIG. 2, assistive scene generation module 202 receives a natural language instruction from user device 212. Multi-step planning module 302 receives the natural language prompt and scene graph 206, which are both used to generate a scene graph according to the natural language instructions. In some examples, the operations of assistive scene generation module 202 (including all or a portion of the modules therein) are executed by LLM 204, as described in FIG. 2. For example, LLM 204 performs the operations of multi-step planning module 302. In some other examples, LLM 204 performs the operations of code generation agent 306.

In some examples, scene graph 206 is from a previous iteration of the LLM-based scene generator. In some other examples, scene graph 206 is a reference scene graph associated with the LLM-based scene generator that operates as a starting point for multi-step planning module 302. In yet another example, user device 212 uploads scene graph 206 via a GUI associated with assistive scene generation module 202. In some examples, scene graph 206 requires a pre-processing procedure to be compatible with assistive scene generation module 20 (e.g., scene graph 206 was generated by an application distinct from an application associated with the LLM-based scene generator). In still yet other examples, the LLM-based scene generator generates a new scene graph from the natural language prompt.

In some examples, the LLM-based scene generator predicts an intent of the user from the natural language prompt. Examples of an intent of the user include, but are not limited to, editing of one or more objects in an existing scene graph (e.g., “make the trees bigger”), creation of a small-scale scene which is likely to only contain a few objects (e.g., “create a living room”), creation of a large-scale scene which is likely to contain many objects and of different types (e.g., “create a city”), etc. If the intent is a direct edit of an existing scene graph, the LLM-based scene generator directs the natural language prompt to scene graph agent 304 and/or code generation agent 306.

In other examples, the intent is a request to create a large-scale and/or a small-scale scene and the LLM-based scene generator directs the natural language prompt to multi-step planning module 302. Multi-step planning module 302 (described in further detail in FIG. 3B) determines a layout associated with the scene graph based on the natural language instruction. In some examples, multi-step planning module 302 receives and processes scene graph 206 to identify one or more objects that are already placed within scene graph 206. Based on scene graph 206, multi-step planning module 302 identifies one or more actions associated with scene graph 206 to generate a scene graph based on the natural language instruction. Multi-step planning module 302 generates an iterative process (e.g., working through levels of increasing granularity within the scene graph), strategy, and/or logic for generating a scene graph according to the natural language instruction (hereinafter referred to as “scene graph logic”).

In some examples, multi-step planning module 302 transmits the scene graph logic to code generation agent 306 and/or scene graph agent 304. In some examples, multi-step planning module 302 transmits the scene graph logic to scene graph agent 304 (described in further detail in FIG. 3C). Multi-step planning module 302 generates a scene graph representation based on the scene graph logic that is compatible with an LLM (e.g., LLM 204 as described in FIG. 2). Using the scene graph logic, scene graph agent 304 performs a generation or editing action (e.g., editing scene graph 206, generating a scene graph from the scene graph logic, etc.). Scene graph agent 304 performs the generation or editing action by querying an LLM (e.g., LLM 204) with a specific prompt that details which object within the scene graph logic should be changed and/or generated and the type of modification. By generating a representation of the scene graph logic (e.g., scene graph representation 332 as described in FIG. 3C), the scene graph is independent from a specific application, 3D modeling software, rendering software, platform, any combination thereof, or the like, and can operate in various computing environments (e.g., operate in different coding languages) without requiring adjustment within assistive scene generation module 202. In some examples, scene graph agent 304 generates a text-based scene graph according to the scene graph logic. In some examples, multi-step planning module 302 transmits the scene graph logic to code generation agent 306 (described in further detail in FIG. 3D). Code generation agent 306 generates code corresponding to the scene graph logic. Code generation agent 306 generates code that complements scene graph agent 304. The corresponding code includes detailed coding algorithms and/or function calls to execute the scene graph logic to generate the scene graph. Code generation agent 305 generates the corresponding code using one or more code libraries, application programming interfaces, dynamically generated code (e.g., procedurally generated or generated using an LLM such as LLM 204, etc.), previous generated code from the LLM, combinations thereof and/or the like. This functionality enables easier generation of larger-scale and/or finer-grained scene graphs. In some examples, multi-step planning module 302 transmits the scene graph logic to code generation agent 306 and scene graph agent 304. In such an example, code generation agent 306 and scene graph agent 304 each process all of the scene graph logic or a portion of the scene graph logic.

Utilizing scene graph agent 304 and/or code generation agent 306 improves the efficiency of future iterations of assistive scene generation module 202 (e.g., receiving additional natural language prompts indicating modifications to a prior-generated scene graph). LLM 204 (as described in FIG. 2) accesses the scene graph representation (as generated by scene graph agent 304) and/or code (as generated by code generation agent 306) to make modifications, rather than repeating the processing by multi-step planning module 302 entirely. Further, in some examples, the LLM-based scene generator exports the text-based scene graph and/or code to other applications outside LLM-based scene generator.

Scene composition module 310 receives the output of at least one of code generation agent 306 and scene graph agent 304. Scene composition module 310 executes the code from code generation agent 306 and/or the scene graph representation from scene graph agent 304. In some examples, scene composition module 310 generates a layout map. In some examples, the layout map is a n-dimensional representation (e.g., two-dimensional, three dimensional, etc.) of the scene graph representation received from scene graph agent 304 (e.g., scene graph representation 332 as described in FIG. 3C) and/or code generation agent 306 (e.g., code 344 as described in FIG. 3D). For example, the layout map includes one or more objects associated with the scene graph placed in a two-dimensional space. The one or more objects are associated with at least a size (indicated by a boundary associated with the object) and an orientation (indicated by an arrow or another representation of direction associated with the object). The one or more objects are further associated with a name, a description, a size, keywords, a style, a color, an orientation, any combination thereof, or the like. In some examples, scene composition module 310 generates a 3D mesh based on the layout map. Scene composition module retrieves and/or generates independent 3D object assets and combines them into the 3D mesh according to the layout map. The 3D mesh places the one or more objects of the layout map in a 3D space based on the size and orientation of the one or more objects. Scene composition module 310 outputs the 3D mesh as a scene graph to evaluation and revision 308 and/or post-processing module 208.

Evaluation and revision 308 analyzes the scene graph according to a series of pre-determined standards (e.g., as determined by an administrator of the LLM-based scene generator, determined by the user of user device 212, determined by settings associated with assistive scene generation module 202, learned by LLM 204, any combination thereof, or the like). In some examples, evaluation and revision 308 may be performed by LLM 204. In some other examples, evaluation and revision 308 may be performed by another machine-learning model. For example, the evaluation and revision 308 performs a raw, rule-based check to determine whether two objects are occluded (e.g., overlapping, etc.), if an object that cannot fly is floating in the air, whether the layout is stylistically accurate (e.g., ensuring a large fountain is not in the middle of a playground area), etc. In some examples, evaluation and revision 308 analyzes the code generated by code generation agent 306 to identify errors (e.g., a rule-based check). In some examples, evaluation and revision 308 analyzes the text-based scene graph generated by scene graph agent 304 (e.g., checking grammar and spelling). In some examples, evaluation and revision 308 identifies at least one error in the scene graph. The error is identified and used to further train LLM 204. In some examples, the scene graph is modified with a second natural language instruction (e.g., scene graph 206). Assistive scene generation module 202 fixes the at least one error identified by evaluation and revision 308 in the processing of the second natural language instruction and the generation of a modified scene graph.

Scene composition module 310 also transmits the scene graph to post-processing module 208. Post-processing module 208 performs rendering and post-processing procedures on the scene graph. In some examples, post-processing module 208 modifies the scene graph to adapt to a specification application, use case, export, interface, code environment, any combination thereof, or the like. In some examples, post-processing module 208 performs a realistic rendering of the scene graph. In some examples, post-processing module 208 utilizes LLM 204 (as described in FIG. 2) to render the scene graph. In some other examples, post-processing module 208 utilizes a second LLM, configured and trained to perform realistic 3D renderings. In yet some other examples, post-processing module 208 does not use machine learning to perform realistic 3D renderings.

In some examples, post-processing module 208 retrieves 3D model assets corresponding to the one or more objects of the scene graph using a CLIP score. A CLIP score is a similarity metric derived from a CLIP model, which evaluates an alignment between an image and a textual description by mapping both inputs into a shared multimodal embedding space. Post-processing module 208 calculates the score using cosine similarity between the image and text embeddings, enabling precise quantification of the semantic correspondence between the image and text embeddings. In some examples, post-processing module 208 retrieves 3D model assets using object morphology front identification via visual prompting. In this example, post-processing module 208 renders a set of four object renderings associated with an object of the layout map and prompt the LLM to identify the morphology front so that the 3D model asset correctly aligns with the object of the layout map.

Post-processing module 208 presents the complete rendering via the user interface of user device 212. User device 212 transmits additional natural language prompts pertaining to the scene graph indicating modifications to the scene graph. For example, user device 212 transmits instructions such as, “add more picnic tables to the picnic area,” “move the swings closer to the slides on the playground,” “add a basketball court to the park,” etc.

FIG. 3B illustrates an example block diagram of a multi-step planning module of the LLM-based scene generator according to some aspects of the present disclosure. In some examples, multi-step planning module 302 includes one or more components, including, but not limited to, multi-step planning manager 312, object identifier 314, object placement 316, and level manager 318. These components operate alone or in combination to perform the functionality of multi-step planning module 302, which includes generating scene graph logic 320 from natural language prompt 322.

Multi-step planning manager 312 interprets and implement instructions from natural language prompt 322. Multi-step planning manager 312, using LLM 204, interprets the natural language prompt 322. In some examples, multi-step planning manager 312 includes natural language processing (NLP) processor, including named entity recognition (NER) and dependency parsing, to identify objects, actions, intents, and relations included in natural language prompt 322. For example, multi-step planning module 302 interprets elements including, but not limited to, identifying an “edit” instruction, identifying a “generate” instruction, identifying size constraints, identifying a context, identifying requested objects, identifying a predicted number of levels for the scene graph, any combination thereof, or the like. In some examples, multi-step planning manager 312 receives constraints from a central manager associated with assistive scene generation module 202. Examples of constraints include, but are not limited to, a size, a number of levels, a threshold detail level (e.g., the level of the highest granularity includes objects of a specific size range), any combination thereof, or the like. Using this information from the constraints and the natural language prompt 322, multi-step planning manager 312 generates instructions for generating a current level of the scene graph. In some examples, the instructions include, but are not limited to, a size, a context, object sizes, object specificity (e.g., a level of generality associated with a particular object, where the lowest level (e.g., 0) indicates that a size of the particular object and the size of the total area of the scene graph are within a threshold ratio and is associated with a generic context such as “park,” and higher levels (e.g., 0.25, 0.6, 1) are associated with respective thresholds and less generic contexts, such as “monkey bars,” “fountain,” “picnic table,” “walking trail,” etc.), any combination thereof, or the like. In some examples, based on the interpreted intent of natural language prompt 322, multi-step planning module 302 queries scene graph 206 (as described in FIG. 2 and FIG. 3A) for scene graph logic associated with scene graph 206. In some examples, multi-step planning manager 312 the components of multi-step planning module 302 to edit the scene graph logic associated with scene graph 206. In some other examples, the instructions cause multi-step planning module 302 to generate a scene graph based on the scene graph logic associated with scene graph 206 (e.g., the scene graph logic associated with scene graph 206 is utilized as a reference scene graph).

Based on the identified elements of natural language prompt 322, object identifier 314 selects objects to include in scene graph logic 320. In some examples, object identifier 314 queries LLM 204 to generate one or more objects for the current level that satisfy the instructions from multi-step planning manager 312. For example, LLM 204 generates four objects (e.g., a park, a shopping center, a residential neighborhood, and a road) for the scene graph that are within a threshold size provided by the instructions, are associated with a context provided by the instructions, are associated with a level of generality provided by the instructions, any combination thereof, or the like. In some examples, object identifier 314 identifies attributes associated with the one or more generated objects that include, but are not limited to, attributes pertaining to characteristics of the object, such as a color, an orientation, three-dimensional dimensions, a context, spatial coordinates, geometric properties, interaction constraints, any combination thereof, or the like. For example, the attributes include one or more contexts associated with the one or more objects (e.g., “park,” “playground,” and “swing” are all associated with one object). In some examples, object identifier 314 stores the one or more objects and associated attributes in a custom data structure defined by multi-step planning module 302. Assistive scene generation module 202 configures the custom data structure to store one or more objects in relation to one another as generated by multi-step planning module 302. In some examples, the custom data structure stores an object and relevant characteristics of the object, such as a size, an orientation, characteristics, tags, context, relevancy metric, any combination thereof, or the like. In some examples, the custom data structure stores image data. For example, scene graph logic 320 includes a scene graph from a previous iteration (e.g., scene graph 206) of the assistive scene generation module 202.

Multi-step planning module 302 implements the custom data structure to represent and store scene graph information, facilitating structured interpretation and processing by code generation agent 306 and scene graph agent 304. In some examples, multi-step planning module 302 includes or has access to a database of custom data structures (e.g., local storage, cloud-based storage, etc.). In some examples, multi-step planning module 302 represents the data structure (e.g., scene graph logic 320) a graph-based model including nodes and edges. Nodes of the graph-based model correspond to objects within the scene and edges of the graph-based model encode relationships between objects. Each node and/or edge includes zero or more attributes that define properties such as location (e.g., as spatial coordinates), shape (e.g., as geometric properties), and interaction constraints (e.g., affixed to the ground, overlay restrictions, etc.). Multi-step planning module 302 increases the efficiency of the data structure using adjacency matrices, hierarchical spatial indexing, or tree-based partitioning schemes. The increased efficiency of the data structure enables efficient traversal, retrieval, and modification, thereby reducing a computational load and reducing latency for assistive scene generation module 202 to generate scene graphs.

Object identifier 314 transmits the one or more generated objects, the attributes, and/or the instructions to object placement 316. Object placement 316 queries LLM 204 to place the one or more objects within a two-dimensional area (restrained by a size provided by the instructions). In some examples, object placement 316 generates additional attributes associated with the one or more objects that are associated with the location of the one or more objects within the two-dimensional area. For example, the additional attributes includes a location of a first object in relation to a location of a second object. As another example, the additional attributes includes a location of a first object in relation to a boundary associated with the two-dimensional area. As yet another example, the additional attributes include an orientation associated with a first object in the form of a degree, a direction, in relation to a second object, and/or in relation to the boundary of the two-dimensional area. In some examples, the additional attributes associated with the one or more objects are stored in scene graph logic 320 defined by multi-step planning module 302.

Object placement 316 transmits the one or more generated objects, the attributes, the additional attributes, and/or the instructions to level manager 318. Level manager 318 also accesses the custom data structure (e.g., scene graph logic 320). Level manager 318 determines whether to execute further iterations of the multi-step planning module 302 to achieve a threshold level of completeness as indicated by the instructions of multi-step planning manager 312. For example, level manager 318 identifies a geometric size associated with the one or more objects, the number of levels (e.g., iterations) completed, settings associated with a minimum number of levels received from assistive scene generation module 202, contexts associated with the one or more objects (e.g., the level of generality associated with the highest level of granularity of object), the intent associated with natural language prompt 322, etc., to determine if a threshold level of completeness is achieved. In some examples, level manager 318 employs LLM 204 to determine whether to execute further iterations of the multi-step planning module 302. If level manager 318 determines to execute further iterations of the multi-step planning module 302 (e.g., context terms are too generic, object size is too large, minimum number of levels has not been reached, etc.), then level manager 318 transmits scene graph logic 320 to multi-step planning manager 312 for further processing. If level manager 318 determines that scene graph logic 320 is complete, and level manager 318 transmits scene graph logic 320 to code generation agent 306 and/or scene graph agent 304.

FIG. 3C illustrates an example block diagram of a scene graph agent of the LLM-based scene generator according to some aspects of the present disclosure. In some examples, scene graph agent 304 includes at least parser 326, representation generator 328, and compiler 330, which operate alone or in combination to perform the functionality of scene graph agent 304. Multi-step planning module 302 transmits scene graph logic 320 to scene graph agent 304. Using the components described herein, scene graph agent 304 transforms scene graph logic 320 into scene graph representation 332. In some examples, scene graph representation 332 is an internal representation of the scene graph logic that is independent from a specific application, 3D modeling software, rendering software, platform, any combination thereof, or the like, and can operate in various computing environments (e.g., operate in different coding languages) without requiring adjustment within assistive scene generation module 202 (as described in FIG. 2).

In some examples, parser 326 converts scene graph logic 320 (e.g., custom data structure, images, video, text, etc.) into a structured form for scene graph agent 304. In some examples, scene graph logic 320 includes image data associated with a prior iteration (e.g., prior scene graph generation) of assistive scene generation module 202 (e.g., scene graph 206). In the context of image data, parser 326 uses computer vision techniques like object detection (e.g., using convolutional neural networks, CNNs, or transformers) to identify distinct objects within the scene graph logic from the previous iteration. In some examples, parser 326 utilizes semantic segmentation to assign labels to pixels in the scene graph from the previous iteration. The labels categorize regions corresponding to objects. Additionally, parser 326 analyzes spatial relationships (e.g., proximity, orientation) between objects in the scene graph from the previous iteration and extracts features such as color, size, and texture using pre-trained models. In textual data, parser 326 relies on natural language processing (NLP) techniques, including named entity recognition (NER) and dependency parsing, to identify objects, actions, and relations described in scene graph logic 320. In some examples, the output (e.g., parsed scene graph logic) of parser 326 is a preliminary object list and associated attributes, which is then processed further by other components.

In some examples, parser 326 transmits parsed scene graph logic to representation generator 328. Representation generator 328 receives the parsed scene graph logic and utilizes LLM 204 to create a contextually aware and coherent scene graph representation. LLM 204 interprets the parsed scene graph logic using inferential modeling and contextual reasoning to resolve ambiguities, derive implicit relationships, and generate a structured scene graph with semantic precision. In some examples, representation generator 328 queries LLM 204 with a specific prompt pertaining to an editing or generating action associated with scene graph logic 320. In some examples, the specific prompt details which object within scene graph logic 320 should be changed and/or generated and the type of modification required.

In some examples, LLM 204 is trained on visual and textual data to recognize explicit objects and relationships and implicit objects and relationships. For example, the parsed scene graph data includes data that indicates a “dog near a ball at a park,” which LLM 204 interprets as an implication that the dog is playing with the ball at the park. Representation generator 328 verifies that the scene graph representation reflects realistic and accurate relationships between objects (e.g., “person sitting on chair,” “dog barking at person”). This includes formatting the data into a graph structure where nodes represent objects and edges represent relationships (hereinafter “scene graph representation”). In some examples, LLM 204 utilizes attention mechanisms to assign weights to different parts of the scene graph, thereby improving how well LLM 204 handles complex interactions, occlusions, or abstract reasoning.

Representation generator 328 transmits the scene graph representation to compiler 330. Compiler 330 translates the scene graph into a renderable format, enabling additional processing by other components of assistive scene generation module 202 (e.g., for processing by scene composition module 310). In some examples, compiler 330 converts the scene graph representation into one or more of 3D models, texture maps, and lighting setups to create a visual scene within a digital environment. Compiler 330 outputs scene graph representation 332. In some examples, scene graph representation 332 is independent from a specific application, 3D modeling software, rendering software, platform, any combination thereof, or the like, and can operate in various computing environments (e.g., operate in different coding languages) without requiring adjustment.

FIG. 3D illustrates an example block diagram of a code generation agent of the LLM-based scene generator according to some aspects of the present disclosure. In some examples, code generation agent 306 includes at least controller 334, parser 336, code generation 338 (e.g., including APIs 340), and compiler 342, which operate alone or in combination to perform the functionality of code generation agent 306. Multi-step planning module 302 transmits scene graph logic 320 to code generation agent 306. Using the components described herein, code generation agent 306 transforms scene graph logic 320 into code 344. In some examples, code 344 includes detailed coding algorithms and/or function calls to execute scene graph logic 320 to generate the scene graph.

Controller 334 manages the execution pipeline of the code generation agent. Controller 334 interfaces with parser 336 to preprocess scene graph logic 320, utilizes code generation 338 for inference, and transmits output to compiler 342 for validation. In some examples, controller 334 integrates with external tooling, including, but not limited to, integrated development environments (IDEs), version control systems, and continuous integration/continuous deployment (CI/CD) pipelines.

In some examples, parser 336 conducts syntactic and semantic preprocessing of scene graph logic 320, facilitating structured interpretation for additional processing at code generation 338. In some examples, when handling scene graph logic 320, parser 336 transforms the custom data structure of scene graph logic 320 into a machine-readable representation by extracting relevant elements of scene graph logic 320. Parser 336 transmits the parsed scene graph logic to code generation 338. In some examples, code generation 338 employs LLM 204 to generate code from parsed scene graph logic. In some examples, LLM 204 to identify correct code-generation APIs (or other code libraries) to call to populate the scene graph. For example, code generation 338, using LLM 204, calls APIs 340 to retrieve documentation, dependency metadata, or real-time validation feedback to generate code.

Compiler 342 validates, optimizes, and executes the generated code, ensuring compliance with language specifications and runtime constraints. This includes, but is not limited to, lexical analysis, syntax verification, semantic checking, and code generation into machine-executable formats. Compiler 342, in some examples, implements performance profiling and optimization techniques (e.g., just-in-time (JIT) compilation or intermediate representation (IR) transformations) to enhance execution efficiency. Compiler 342 generates code 344 and exports code 344 for rendering, to additional components of assistive scene generation module 202, to an external processing system, any combination thereof, or the like.

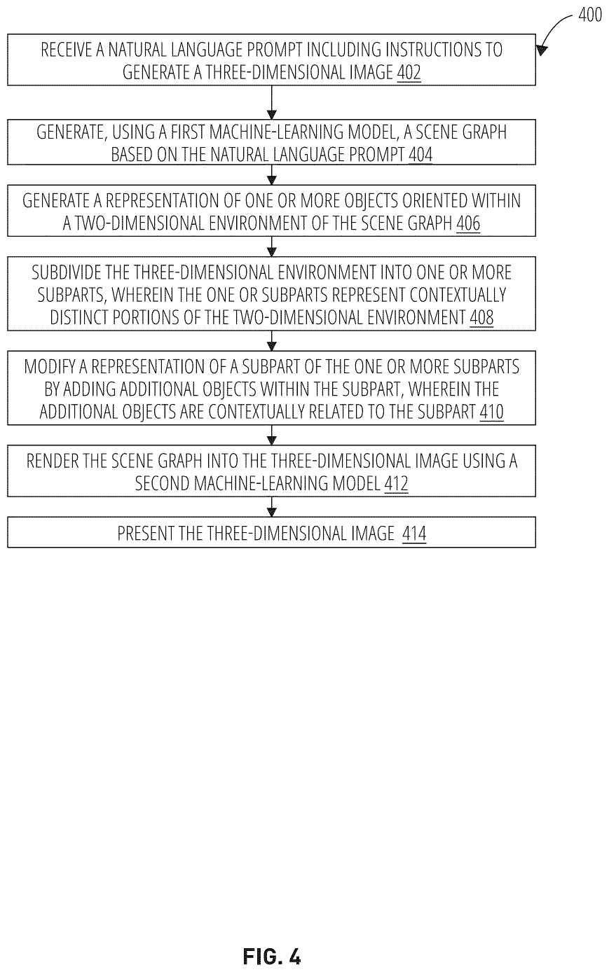

FIG. 4 illustrates an example flowchart for generating a three-dimensional scene using the LLM-based scene generator according to some aspects of the present disclosure.

At step 402, LLM-based scene generator receives a natural language prompt including instructions to generate a three-dimensional scene. LLM-based scene generator receives the natural language prompt from a user device via keyboard input, touchscreen input, microphone input, any combination thereof, or the like.

At step 404, LLM-based scene generator generates, using a first machine-learning model, a scene graph based on the natural language prompt, wherein the first machine-learning model generates the scene graph by performing step 406, step 408, and step 410. At step 406, LLM-based scene generator 400 generates a representation of one or more objects oriented within a two-dimensional environment of the scene graph. The first machine-learning model generates a layout map that includes large-scale portions of the scene graph (e.g., a layout for a city with a park, a downtown, a residential area, and a school). The large-scale portions are associated with a context. The large-scale portions are associated with one or more conditions, including at least a size (indicated by a boundary in the two-dimensional space) and an orientation (indicated by a symbol, such as an arrow, in the two-dimensional space).

At step 408, LLM-based scene generator subdivides the two-dimensional environment into one or more subparts, wherein the one or subparts represent contextually distinct portions of the two-dimensional environment. The first machine-learning model then identifies sub-regions within the large-scale portions that are smaller than the large-scale portion (e.g., a layout for the park within the city, a layout for a subdivision in the residential area, etc.), which are associated with the respective context of the associated large-scale portion (e.g., the large-scale portion is associated with the “park” context, therefore the sub-regions of the large-scale portion are also associated with the “park” context). In some examples, the one or more subparts (e.g., sub-regions) are contextually distinct from each other, but maintain an association with the context of the associated large-scale portion (e.g., “swings” and “fountain” are distinct from each other, but are still associated with “park”). The contextual information associated with the regions of the scene graph improve the technical quality and accuracy of the scene graph (e.g., preventing unrealistic layouts in the scene graph, such as a used car dealership within a city park).

At step 410, LLM-based scene generator modifies a representation of a subpart of the one or more subparts by adding additional objects within the subpart, wherein the additional objects are contextually related to the subpart. In some examples, the sub-regions are further divided into additional sub-regions (e.g., a layout for a playground on the park within the city, the layout of a cul-de-sac of the subdivision in the residential area). For example, the multi-step reasoning workflow identifies a large-scale portion, then splits the large-scale portion into one or more first sub-regions, then splits the one or more first sub-regions into respective one or more second sub-regions. The multi-step reasoning workflow continues to generate levels of sub-regions until the scene graph achieves a level of completeness indicated by the natural language prompt.

At step 412, LLM-based scene generator renders the scene graph into the three-dimensional scene using a second machine-learning model. The LLM-based scene generator generates the rendering using the completed scene graph (comprised of a 3D mesh based on a layout map). The LLM-based scene graph utilizes the 3D mesh to generate a life-like rendering of the scene graph. In some examples, the LLM-based scene generator retrieves 3D model assets corresponding to the object of the scene graph (the layout map and the 3D mesh) using a Contrastive Language-Image Pre-training Model (CLIP) score. A CLIP score is a similarity metric derived from a CLIP model, which evaluates the alignment between an image and a textual description by mapping both inputs into a shared multimodal embedding space. The CLIP model calculates the CLIP score using cosine similarity between the image and text embeddings, enabling precise quantification of their semantic correspondence. In some examples, the LLM-based scene generator retrieves 3D model assets using object morphology front identification via visual prompting. In this example, the LLM-based scene generator renders a set of four object renderings associated with an object of the layout map and prompt the LLM to identify the morphology front so that the 3D model asset correctly aligns with the object of the layout map.

At step 414, LLM-based scene generator 400 presents the three-dimensional scene. The LLM-based scene generator presents the rendering via a user interface of the user device. The user device transmits additional natural language prompts pertaining to the scene graph indicating modifications to the scene graph. For example, the user device transmits instructions such as, “add more picnic tables to the picnic area,” “move the swings closer to the slides on the playground,” “add a basketball court to the park,” etc.

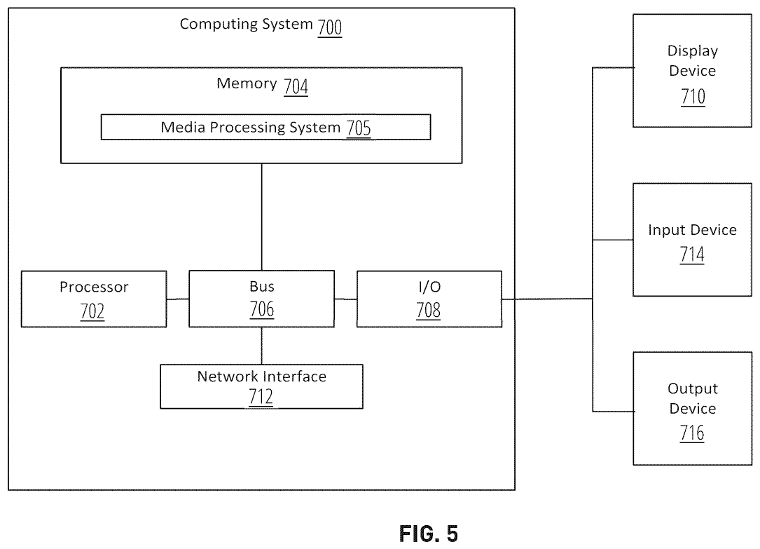

Any suitable computing system or group of computing systems can be used for performing the operations described herein. For example, FIG. 5 depicts a computing system 502 that can implement any of the computing systems or environments discussed above. In some embodiments, the computing system 502 includes a processing device 504 that executes the media processing system, a memory that stores various data computed or used by the media processing system, an input device 516 (e.g., a mouse, a stylus, a touchpad, a touch-screen, etc.), and an output device 518 that presents output to a user (e.g., a display device that displays graphical content generated by media processing system). For illustrative purposes, FIG. 5 depicts a single computing system on which the media processing system is executed, and the input device 516 and output device 518 are present. But these applications, datasets, and devices can be stored or included across different computing systems having devices similar to the devices depicted in FIG. 5.

The example of FIG. 5 includes a processing device 504 communicatively coupled to one or more memory devices 506. The processing device 504 executes computer-executable program code stored in memory devices 506, accesses information stored in the memory devices 506, or both. Examples of the processing device 504 include a microprocessor, an application-specific integrated circuit (“ASIC”), a field-programmable gate array (“FPGA”), or any other suitable processing device. The processing device 504 can include any number of processing devices, including a single processing device.

The memory devices 506 include any suitable non-transitory computer-readable medium for storing data, program code, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions could include processor-specific instructions generated by a compiler or an interpreter from code written in any suitable computer-programming language, including, for example, C, C++, C#, Visual Basic, Java, Python, Perl, JavaScript, and ActionScript.

The computing system 502 could also include a number of external or internal devices, such as a display device 512, or other input or output devices. For example, the computing system 502 is shown with one or more input/output (“I/O”) interfaces 510. I/O interfaces 510 can receive input from input devices or provide output to output devices. One or more buses 508 are also included in the computing system 502. Buses 508 communicatively couple one or more components of the computing system 502 to each other or to an external component.

The computing system 502 executes program code that configures the processing device 702 to perform one or more of the operations described herein. The program code includes, for example, code implementing the assistive scene generation module 202 or other suitable applications that perform one or more operations described herein. The program code can be resident in the memory devices 506 or any suitable computer-readable medium and can be executed by the processing device 504 or any other suitable processor. In some embodiments, all modules in the media processing system are stored in the memory devices 506, as depicted in FIG. 5. In additional or alternative embodiments, one or more of these modules from the media processing system are stored in different memory devices of different computing systems.

In some embodiments, the computing system 502 also includes a network interface device 514. The network interface device 514 includes any device or group of devices suitable for establishing a wired or wireless data connection to one or more data networks. Non-limiting examples of the network interface device 514 include an Ethernet network adapter, a modem, and/or the like. The computing system 502 is able to communicate with one or more other computing devices (e.g., a computing device that receives inputs for assistive scene generation module 202 or displays outputs of assistive scene generation module 202) via a data network using the network interface device 514.

An input device 516 can include any device or group of devices suitable for receiving visual, auditory, or other suitable input that controls or affects the operations of the processing device 504. Non-limiting examples of the input device 516 include a touchscreen, stylus, a mouse, a keyboard, a microphone, a separate mobile computing device, etc. An output device 518 can include any device or group of devices suitable for providing visual, auditory, or other suitable sensory output. Non-limiting examples of the output device 518 include a touchscreen, a monitor, a separate mobile computing device, etc.

Although FIG. 5 depicts the input device 516 and the output device 518 as being local to the computing device that executes the assistive scene generation module 202, other implementations are possible. For instance, in some embodiments, one or more of the input devices 516 and the output device 518 include a remote client-computing device that communicates with the computing system 502 via the network interface device 514 using one or more data networks described herein.

The following examples illustrate various aspects of the present disclosure. As used below, any reference to a series of examples is to be understood as a reference to each of those examples disjunctively (e.g., “Examples 1-4” is to be understood as “Examples 1, 2, 4, or 4”).

Example 1 includes a computer-implemented method, comprising: receiving a natural language prompt including instructions to generate a three-dimensional scene; generating, using a first machine-learning model, a scene graph based on the natural language prompt, wherein the first machine-learning model generates the scene graph by: generating a representation of one or more objects oriented within a two-dimensional environment of the scene graph, subdividing the two-dimensional environment into one or more subparts, wherein the one or subparts represent contextually distinct portions of the two-dimensional environment; and modifying a representation of a subpart of the one or more subparts by adding additional objects within the subpart, wherein the additional objects are contextually related to the subpart; rendering the scene graph into the three-dimensional scene using a second machine-learning model; and presenting the three-dimensional scene.

Example 2 includes the computer-implemented method of example(s) 1, wherein the instructions include a representation of an image.

Example 3 includes the computer-implemented method of example(s) 1-2, further comprising: receiving feedback associated with the scene graph; evaluating the scene graph based on the feedback; and updating the first machine-learning model based on the feedback.

Example 4 includes the computer-implemented method of example(s) 1-3, wherein generating, using a first machine-learning model, a scene graph based on the natural language prompt, further includes: generating a three-dimensional mesh based on the two-dimensional environment that includes the representation of the one or more objects in a three-dimensional environment.

Example 5 includes the computer-implemented method of example(s) 1-4, wherein the scene graph is associated with one or more conditions including a type of object, a number of objects, and a size of the first scene graph.

Example 6 includes the computer-implemented method of example(s) 1-5, further comprising: executing a first iteration modifying a first representation of a first subpart of the one or more subparts; and executing a second iteration modifying a second representation of a second subpart of the one or more subparts, wherein the second iteration is associated with a context prompt based on the first iteration.

Example 7 includes the computer-implemented method of example(s) 1-6, wherein rendering the first scene graph into the three-dimensional scene using a second machine-learning model further includes: retrieving one or more objects associated with the first scene graph to composite into the three-dimensional scene; orienting the one or more objects according to the first scene graph; and compositing the one or more objects into the three-dimensional scene.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to further limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

1. A computer-implemented method, comprising:
receiving a natural language prompt including instructions to generate a three-dimensional scene;
generating, using a first machine-learning model, a scene graph based on the natural language prompt, wherein the first machine-learning model generates the scene graph by:
generating a representation of one or more objects oriented within a two-dimensional environment of the scene graph,
subdividing the two-dimensional environment into one or more subparts, wherein the one or more subparts represent contextually distinct portions of the two-dimensional environment; and
modifying a representation of a subpart of the one or more subparts by adding additional objects within the subpart, wherein the additional objects are contextually related to the subpart;
rendering the scene graph into the three-dimensional scene; and
presenting the three-dimensional scene.

2. The computer-implemented method of claim 1, wherein the instructions include a representation of an image.

3. The computer-implemented method of claim 1, further comprising:
receiving feedback associated with the scene graph;
evaluating the scene graph based on the feedback; and
updating the first machine-learning model based on the feedback.

4. The computer-implemented method of claim 1, wherein generating, using a first machine-learning model, a scene graph based on the natural language prompt, further includes:
generating a three-dimensional mesh based on the two-dimensional environment that includes the representation of the one or more objects in a three-dimensional environment.

5. The computer-implemented method of claim 1, wherein the scene graph is associated with one or more conditions including a type of object, a number of objects, and a size of the scene graph.

6. The computer-implemented method of claim 1, further comprising:
executing a first iteration modifying a first representation of a first subpart of the one or more subparts; and
executing a second iteration modifying a second representation of a second subpart of the one or more subparts, wherein the second iteration is associated with a context prompt based on the first iteration.

7. The computer-implemented method of claim 1, wherein rendering the scene graph into the three-dimensional scene using a second machine-learning model further includes:
retrieving one or more objects associated with the scene graph to composite into the three-dimensional scene;
orienting the one or more objects according to the scene graph; and
compositing the one or more objects into the three-dimensional scene.

8. A system comprising:
one or more processors; and
a memory storing instructions that, when executed by the one or more processors, configure the system to:
receive a natural language prompt and a reference scene graph, wherein the natural language prompt includes instructions to generate a three-dimensional scene;
generate, using a first machine-learning model, a scene graph based on the natural language prompt and the reference scene graph, wherein the first machine-learning model generates the scene graph by:
generating a representation of one or more objects oriented within a two-dimensional environment of the scene graph,
subdividing the two-dimensional environment into one or more subparts; and
modifying a representation of a subpart of the one or more subparts by adding additional objects within the subpart;
render the scene graph into the three-dimensional scene using a second machine-learning model; and
present the three-dimensional scene.

9. The system of claim 8, wherein the instructions include a representation of an image.

10. The system of claim 8, wherein the instructions further configure the system to:
receive feedback associated with the scene graph;
evaluate the scene graph based on the feedback; and
update the first machine-learning model based on the feedback.

11. The system of claim 8, wherein generating, using a first machine-learning model, a scene graph based on the natural language prompt, further includes:
generating a three-dimensional mesh based on the two-dimensional environment that includes the representation of the one or more objects in a three-dimensional environment.

12. The system of claim 8, wherein the scene graph is associated with one or more conditions include a type of object, a number of objects, and a size of the scene graph.

13. The system of claim 8, wherein the instructions further configure the system to:
execute a first iteration modifying a first representation of a first subpart of the one or more subparts; and
execute a second iteration modifying a second representation of a second subpart of the one or more subparts, wherein the second iteration is associated with a context prompt based on the first iteration.

14. The system of claim 8, wherein rendering the scene graph into the three-dimensional scene using a second machine-learning model further includes:
retrieve one or more objects associated with the scene graph to composite into the three-dimensional scene;
orient the one or more objects according to the scene graph; and
compositing the one or more objects into the three-dimensional scene.

15. A non-transitory computer-readable storage medium, the computer-readable storage medium including instructions that when executed by a computer, cause the computer to:
receive a natural language prompt including instructions to generate a three-dimensional scene;
generate, using a first machine-learning model, a scene graph based on the natural language prompt, wherein the first machine-learning model generates the scene graph by:
generating a representation of one or more objects oriented within a two-dimensional environment of the scene graph,
subdividing the two-dimensional environment into one or more subparts, wherein the one or more subparts represent contextually distinct portions of the two-dimensional environment;
modifying a representation of a subpart of the one or more subparts by adding additional objects within the subpart, wherein the additional objects are contextually related to the subpart; and
generating a three-dimensional mesh based on the two-dimensional environment that includes the representation of the one or more objects in a three-dimensional environment;
render the scene graph into the three-dimensional scene using a second machine-learning model; and
present the three-dimensional scene.

16. The non-transitory computer-readable storage medium of claim 15, wherein the instructions include a representation of an image.

17. The non-transitory computer-readable storage medium of claim 15, wherein the instructions further configure the computer to:
receive feedback associated with the scene graph;
evaluate the scene graph based on the feedback; and
update the first machine-learning model based on the feedback.

18. The non-transitory computer-readable storage medium of claim 15, wherein the scene graph is associated with one or more conditions include a type of object, a number of objects, and a size of the scene graph.

19. The non-transitory computer-readable storage medium of claim 15, wherein the instructions further configure the computer to:
execute a first iteration modifying a first representation of a first subpart of the one or more subparts; and
execute a second iteration modifying a second representation of a second subpart of the one or more subparts, wherein the second iteration is associated with a context prompt based on the first iteration.

20. The non-transitory computer-readable storage medium of claim 15, wherein rendering the scene graph into the three-dimensional scene using a second machine-learning model further includes:
retrieve one or more objects associated with the scene graph to composite into the three-dimensional scene;
orient the one or more objects according to the scene graph; and
compositing the one or more objects into the three-dimensional scene.
